(19) United States
(12) Patent Application Publication
(10) Pub. No.: US 2022/0128917 A1
(43) Pub. Date: Apr. 28, 2022

(54) TONER, TONER STORED CONTAINER, DEVELOPER, DEVELOPING DEVICE, PROCESS CARTRIDGE, AND IMAGE FORMING APPARATUS

(71) Applicants: Hyo Shu, Shizuoka (JP); Hisashi Nakajima, Shizuoka (JP); Yoshitaka Yamauchi, Shizuoka (JP); Katsunori Kurose, Shizuoka (JP)

(72) Inventors: Hyo Shu, Shizuoka (JP); Hisashi Nakajima, Shizuoka (JP); Yoshitaka Yamauchi, Shizuoka (JP); Katsunori Kurose, Shizuoka (JP)

(73) Assignee: Ricoh Company, Ltd., Tokyo (JP)

(21) Appl. No.: 17/422,808

(22) PCT Filed: Nov. 6, 2019
(86) PCT No.: PCT/JP2019/043438

§ 371 Date: Jul. 14, 2021

(30) Foreign Application Priority Data
Jan. 23, 2019 (JP) 2019-009175
Jul. 19, 2019 (JP) 2019-133282

(51) Int. Cl. G03G 9/097; G03G 15/08; G03G 21/18

(52) U.S. Cl. CPC G03G 9/09708; G03G 21/1814; G03G 15/0865

(57) ABSTRACT

A toner including inorganic particles, wherein the inorganic particles include a fluorine-containing alumina, and the toner satisfies both Formula (1) below and Formula (2) below: 2.7≤X1/X2≤5.5 . . . Formula (1); and 2.1≤X1≤3.0 . . . Formula (2) where X1 denotes a concentration of aluminum in the toner and X2 denotes a concentration of fluorine in the toner, and the concentration of aluminum and the concentration of fluorine are determined through an X-ray photoelectron spectroscopic analysis method.

### TECHNICAL FIELD

The present disclosure relates to a toner, a toner stored container, a developer, a developing device, a process cartridge, and an image forming apparatus.

### BACKGROUND ART

An electrophotographic image forming method includes: a charging step of giving electric charges through electric discharge on a surface of a photoconductor that is a latent image bearer; an exposing step of exposing the surface of the photoconductor charged to form an electrostatic latent image; a developing step of supplying a toner to the electrostatic latent image formed on the surface of the photoconductor to perform developing; a transfer step of transferring, on a recording medium, a toner image on the surface of the photoconductor; and a fixing step of fixing the toner image on the recording medium.

In such an image forming method, in order to improve image quality such as occurrence of an image having fog over time, use of metallic oxide powder that is subjected to a surface treatment with a fluorine-containing compound has been proposed as an external additive of a toner (for example, see PTL 1).

In addition, when the fluorine-containing compound is used for a surface modification treatment, a method for producing a surface-modified alumina powder containing fluorine that has a high frictional electrification amount by adjusting an amount of moisture of the alumina powder has been proposed (for example, see PTL 2).

### CITATION LIST

### Patent Literature

PTL 1: Japanese Unexamined Patent Application Publication No. 60-93455
PTL 2: Japanese Patent No. 4304661

### SUMMARY OF INVENTION

### Technical Problem

An object of the present disclosure is to provide a toner that can prevent occurrence of an image having fog over time under a low-temperature and low-humidity environment (temperature of 10 degrees Celsius and humidity of 15% RH) and can achieve a high image density.

### Solution to Problem

The toner of the present disclosure as a means for achieving the aforementioned object is a toner that includes inorganic particles. The inorganic particles include a fluorine-containing alumina. The toner satisfies both Formula (1) below and Formula (2) below.

2.7≤X1/X2≤5.5 Formula (1)

2.1≤X1≤3.0 Formula (2)

In Formulas (1) and (2), X1 denotes a concentration of aluminum in the toner and X2 denotes a concentration of fluorine in the toner, and the concentration of aluminum and the concentration of fluorine are determined through an X-ray photoelectron spectroscopic analysis (XPS) method.

### Advantageous Effects of Invention

According to the present disclosure, it is possible to provide a toner that can prevent occurrence of an image having fog over time under a low-temperature and low-humidity environment (temperature of 10 degrees Celsius and humidity of 15% RH) and can achieve a high image density.

### BRIEF DESCRIPTION OF DRAWINGS

FIG. 1 is a schematic diagram presenting one example of an image forming apparatus including a process cartridge of the present disclosure.

FIG. 2 is a diagram presenting a characteristic spectrum of a resin of a toner determined through the FTIR-ATR method.

FIG. 3 is a schematic diagram presenting one example of an image forming apparatus having a charging device configured to perform roller charging.

FIG. 4 is a schematic diagram presenting one example of an image forming apparatus including a charging device configured to perform blush charging.

### DESCRIPTION OF EMBODIMENTS

(Toner)

A toner of the present disclosure is a toner including inorganic particles. The inorganic particles include a fluorine-containing alumina. The toner satisfies both Formula (1) below and Formula (2) below.

2.7≤X1/X2≤5.5 Formula (1)

2.1≤X1≤3.0 Formula (2)

In Formulas (1) and (2), X1 denotes a concentration of aluminum in the toner and X2 denotes a concentration of fluorine in the toner, and the concentration of aluminum and the concentration of fluorine are determined through an X-ray photoelectron spectroscopic analysis (XPS) method.

The toner includes other components if necessary.

In the prior art, the fluorine-containing alumina is used as inorganic particles of the toner. However, a presence state of aluminum and fluorine in the fluorine-containing alumina in the toner, an effect of the presence state on characteristic values of the toner, an effect of the characteristic values of the toner on image quality of an image forming apparatus, and an effect of occurrence of an image having fog over time on image quality have not been considered. In addition, there are problems that occurrence of an image having fog over time under a low-temperature and low-humidity environment cannot be prevented and a high image density cannot be achieved.

As a result of diligent studies performed by the present inventors, the following has been found. Specifically, the inorganic particles of the toner include a fluorine-containing alumina. A concentration of aluminum and a concentration of fluorine on the surface layers of the toner particles, particularly the concentration of aluminum and the concentration of fluorine existing from the outermost layer up to a region at a depth of about 5 nm largely affect a charging startup performance: i.e. capability of charging for a short period of time when friction with a carrier having a poor charging ability over time causes the toner to be charged.

Therefore, the following is important. Specifically, in the toner of the present disclosure, the inorganic particles include a fluorine-containing alumina, and the toner satisfies both Formula (1) below and Formula (2) below.

2.7≤X1/X2≤5.5 Formula (1)

2.1≤X1≤3.0 Formula (2)

In Formulas (1) and (2), X1 denotes a concentration of aluminum in the toner and X2 denotes a concentration of fluorine in the toner, and the concentration of aluminum and the concentration of fluorine are determined through an X-ray photoelectron spectroscopic analysis (XPS) method.

When a ratio (X1/X2) of the concentration of aluminum X1 to the concentration of fluorine X2 in the aforementioned Formula (1) is 2.7 or more, fluorine derived from the fluorine-containing alumina can prevent spent (adhesion) on a carrier over time, can improve charging ability of the carrier, makes charging startup performance of the toner excellent under a low-temperature and low-humidity environment (temperature of 10 degrees Celsius and humidity of 15% RH), and decreases the toner that is weakly charged or reversely charged. Therefore, occurrence of an image having fog can be prevented. In addition, when the ratio (X1/X2) is 5.5 or less, the concentration of fluorine contributing to the charging startup performance of the toner becomes appropriate. Therefore, the charging ability of the carrier becomes excellent, the charging startup performance of the toner under a low-temperature and low-humidity environment becomes excellent, and the toner that is weakly charged or reversely charged is decreased, which makes it possible to prevent occurrence of an image having fog.

In addition, when the concentration of aluminum X1 in the aforementioned Formula (2) is 2.1 or more, the saturation charging value of the toner under a low-temperature and low-humidity environment (temperature of 10 degrees Celsius and humidity of 15% RH) becomes appropriate, which makes it possible to obtain a high image density. In addition, when the concentration of aluminum X1 is 3.0 or less, fluorine derived from the fluorine-containing alumina can prevent spent (adhesion) on a carrier over time. Therefore, the charging startup performance of the carrier becomes excellent, and the toner that is weakly charged or reversely charged is decreased, which makes it possible to prevent occurrence of an image having fog.

Furthermore, the X1 and the ratio (X1/X2) preferably satisfy the following Formulas (3) and (4). When the toner satisfies both Formula (3) below and Formula (4) below, occurrence of an image having fog due to shortage of charging startup, which is caused from friction between the toner and the carrier over time under a low-temperature and low-humidity environment, can be prevented, further improving an object such as improvement in the image quality.

2.8≤X1/X2≤5.2 Formula (3)

2.1≤X1≤2.9 Formula (4)

The concentration of aluminum X1 and the concentration of fluorine X2 in the toner through the X-ray photoelectron spectroscopic analysis (XPS) method, and the ratio (X1/X2) can be measured using the following analysis apparatuses based on the following measurement conditions. The unit of X1 and X2 is Atomic %.
Analysis apparatus: X-ray photoelectron spectroscopic analysis apparatus, AXIS-ULTRA (available from SHIMADZU CORPORATION)
X-ray: 15 kV, 9 mA, Hybrid
Neutralizer gun: 2.0 A (F-Current), 1.3 V (F-Bias), 1.8 V (C-Balance)
Step: 0.1 eV (Narrow), 2.0 eV (Wide)
PassE: 20 eV (Narrow), 160 eV (Wide)
Relative sensitivity factor: Relative sensitivity factor of CasaXPS is used.

Regarding the fluorine-containing alumina on the surface layer of the toner, whether fluorine exists on the surface layer of the alumina can be observed through the following method.

A toner is fixed on a piece of carbon tape, and the carbon-coated sample for preventing charge up can be analyzed through scanning electron microscope (SEM) and the energy dispersive X-ray spectrometry apparatus (EDX).

As observation conditions, analysis can be performed by using the SEM of SU8230 (available from Hitachi, Ltd.) and EDX XFlash FlatQUAD 5060F (available from Bruker), photographing the surface of the toner through the SEM under the following conditions: acceleration voltage of 5 kv, 50,000 folds, 180 seconds, and SE (L), and then subjecting at least C, F, and Al elements to mapping through the EDX.

The toner of the present disclosure further includes a release agent and a resin. The toner preferably satisfies a ratio (W/R) of 0.05 or more but 0.14 or less where W denotes a peak height of a characteristic spectrum of the release agent and R denotes a peak height of a characteristic spectrum of the resin, and the peak height of the characteristic spectrum of the release agent and the peak height of the characteristic spectrum of the resin are measured through an ATR (attenuated total reflection) method using FT-IR (Fourier transform infrared spectroscopy) analysis measurement device.

When the ratio (W/R) is 0.05 or more, a range of the release agent (wax) existing on the outermost layer of the toner is appropriate. This makes it possible to prevent the fluorine-containing alumina from being detached (released) from toner base particles due to stirring stress in an image forming apparatus, and makes it possible to prevent adhesion of fluorine on a carrier and occurrence of an image having fog due to shortage of charging startup, which is caused from friction between the toner and the carrier over time. In addition, when the ratio (W/R) is 0.14 or less, a range of the release agent (wax) existing on the outermost layer of the toner is appropriate. This makes it possible to prevent a colorant from being hidden from the toner base particles due to stirring stress in an image forming apparatus to thereby make image density small over time, preventing occurrence of an image having fog.

—Measurement method of peak intensity ratio (W/R)—

In the present disclosure, the peak intensity ratio (W/R) is calculated when a peak height of a characteristic spectrum of the release agent (wax) is W and a peak height of a characteristic spectrum of the resin is R from absorbance spectra measured through an ATR (attenuated total reflection) method using FT-IR (Fourier transform infrared spectroscopy analysis measurement device, Avatar 370, available from Thermo Electron). Because a smooth surface is required in the ATR method, the toner is subjected to compression and molding to form a smooth surface. In the compression and molding at this time, a load (1 t) is applied to the toner (2.0 g) for 60 seconds to obtain a pellet having a diameter of 20 mm.

In the present disclosure, W is a peak height of a characteristic spectrum (peak observed from 2834 cm⁻¹ to 2862 cm⁻¹) derived from C—H stretching of an alkyl chain from a wax, and R is a peak height of a characteristic spectrum of a resin (for example, in the case of a polyester resin, see FIG. 2, a peak observed from at 784 cm⁻¹ to 889 cm⁻¹; and in the case of a styrene-acrylic resin, a peak observed from at 670 cm⁻¹ to 714 cm⁻¹). The W/R is calculated as a peak intensity ratio. When two or more resins are mixed and two or more peaks are detected, the highest peak is used. The peak intensity ratio in the present disclosure is obtained by converting a spectrum to absorbance and then using its peak height.

The toner includes inorganic particles, preferably includes toner base particles, and further includes other particles if necessary.

<Inorganic Particles>

The inorganic particles include a fluorine-containing alumina, preferably include inorganic particles other than the fluorine-containing alumina, and further include other particles if necessary.

—Fluorine-Containing Alumina—

Examples of the fluorine-containing alumina include alumina treated with a fluorine compound.

Examples of the fluorine compound include fluorine-containing silane compounds.

As the fluorine-containing silane compound, a silane compound in which a hydrogen atom of an alkyl group is substituted with a fluorine atom can be used. Examples thereof include C₆F₁₃CH₂CH₂Si(OCH₃)₃ and CF₃CH₂CH₂Si(OCH₃)₃.

<Inorganic Particles Other than Fluorine-Containing Alumina>

A median diameter of the inorganic particles other than the fluorine-containing alumina is preferably 60 nm or more but 300 nm or less.

When the median diameter is 60 nm or more, a spacer effect of the inorganic particles having a large particle diameter will work on the outermost layer of the toner. Therefore, it is possible to prevent decreased image density over time, which is caused by hiding the fluorine-containing alumina from toner base particles due to stirring stress in an image forming apparatus, and to prevent occurrence of an image having fog.

When the median diameter is 300 nm or less, inorganic particles having a large diameter are strongly attached to the outermost layer of the toner. This makes it possible to prevent decreased image density over time, which is caused by detaching the inorganic particles having a large particle diameter from the surface layer of the toner due to stirring stress, suppressing a spacer effect, and then hiding the fluorine-containing alumina from toner base particles due to stirring stress in an image forming apparatus, and to prevent occurrence of an image having fog.

A method for measuring a median diameter of the inorganic particles having a large particle diameter is as follows.

(1) A sample (0.1 g) is sampled in a glass bottle and methanol (20 g) is added thereto, followed by stirring.

(2) The resultant is dispersed for 10 minutes in an ultrasonic dispersing apparatus to obtain a measurement sample.

(3) The sample in (2) is measured using a laser diffraction scattering-type particle size distribution measuring device to determine a median diameter.

The inorganic particles other than the fluorine-containing alumina are not particularly limited so long as the inorganic particles other than the fluorine-containing alumina are inorganic particles having a median diameter of 60 nm or more but 300 nm or less. Examples thereof include silicon oxide (silica).

—Other Particles—

The other particles are not particularly limited and may be appropriately selected depending on the intended purpose so long as the other particles are those other than the inorganic particles such as the inorganic particles including the fluorine-containing alumina and the inorganic particles other than the fluorine-containing alumina and having a median diameter of 60 nm or more but 300 nm or less. Examples thereof include silica, titanium oxide, barium titanate, magnesium titanate, calcium titanate, strontium titanate, iron oxide, copper oxide, zinc oxide, tin oxide, silica sand, clay, mica, tabular spar, diatomaceous earth, chromium oxide, cerium oxide, red oxide, antimony trioxide, magnesium oxide, zirconium oxide, barium sulfate, barium carbonate, calcium carbonate, silicon carbide, and silicon nitride. These may be used alone or in combination.

The other inorganic particles may be subjected to a surface treatment in order to increase hydrophobicity of the surface and to prevent a decrease in a flow characteristic or a charging characteristic even under a high humidity environment.

Examples of a surface treatment agent include fluorine-containing silane coupling agents, silylating agents, silane coupling agents having a fluorinated alkyl group, organic-titanate-based coupling agents, aluminum-based coupling agents, silicone oils, and modified silicone oils.

An amount of the inorganic particles (when two or more inorganic particles are included, the amount of the inorganic particles is the total amount) is preferably 0.4 parts by mass or more but 4.0 parts by mass or less, more preferably 1.0 part by mass or more but 2.2 parts by mass or less relative to 100 parts by mass of the toner base particles.

When the amount thereof is 0.4 parts by mass or more, fluidity and aggregability of the toner can be sufficiently improved, image quality of an halftone image is improved, and such a problem that an image having voids due to aggregation of the toner is not caused. When the amount thereof is 4.0 parts by mass or less, the lower limit of a fixing temperature increases to thereby make the low-temperature fixability good.

<Toner Base Particles>

The toner base particles preferably include a resin and a release agent, and further include other components if necessary.

<<Release Agent>>

The release agent is not particularly limited and may be appropriately selected depending on the intended purpose. Examples thereof include waxes.

Examples of the waxes include: vegetable-based waxes such as carnauba wax, cotton wax, Japan wax, and rice bran wax; animal-based waxes such as bees wax and lanolin; mineral-based waxes such as zokerite and selsyn; and petroleum waxes such as paraffin, microcrystalline, and petrolatum.
In addition to these natural waxes, synthesized hydrocarbon waxes such as FischerTropsch wax, polyethylene, and polypropylene; and synthesized waxes such as ester, ketone, and ether are used.
Examples thereof include: fatty acid amide compounds such as 12-hydroxystearic acid amide, stearic acid amide, anhydrous phthalic imide, and chlorinated hydrocarbon; homopolymers or copolymers of polyacrylates such as poly-n-stearyl methacrylate and poly-n-lauryl methacrylate, which are a low-molecular-weight crystalline polymer resin (e.g., compolymer of n-stearyl acrylate-ethyl methacrylate); and crystalline polymers having a long alkyl group at a side chain thereof.
These release agents may be used alone or in combination.
Among them, carnauba wax, rice bran wax, ester wax, and polypropylene are preferable.
The carnauba wax is a natural wax obtained from leaves of Copernicia cerifera. In particular, those having a low acid value and removing free fatty acid are preferable because uniform dispersion in a resin can be achieved.
The rice bran wax is a natural wax obtained by refining slack wax prepared in the dewaxing or wintering step when rice bran oil extracted from rice bran is refined. The ester wax is a wax synthesized through ester reaction from a monofunctional straight-chain fatty acid and a monofunctional straight-chain alcohol.

An amount of the release agent is not particularly limited and may be appropriately selected depending on the intended purpose. The amount thereof is preferably 0.5 parts by mass or more but 20 parts by mass or less, more preferably 2 parts by mass or more but 10 parts by mass or less relative to 100 parts by mass of the toner.

When the amount thereof is 0.5 parts by mass or more, low-temperature fixability and hot offset resistance at the time of fixing are good. When the amount thereof is 20 parts by mass or less, heat resistant storage stability is good and an image with high quality can be obtained. The amount thereof satisfying the more preferable range as described above is advantageous because high image quality can be achieved and fixing stability can be improved.

<<Resin>>

As the resin, resins obtained through polycondensation reaction such as polyesters, polyamides, and polyester⋅polyamide resins, and resins obtained through addition polymerization reaction such as styrene-acryl and styrene-butadiene can be used. The resin is not particularly limited so long as it is a resin obtained through polycondensation reaction or addition polymerization reaction.

The polyester resin as the resin obtained through polycondensation reaction is a resin obtained through polycondensation of a multivalent hydroxy compound and polybasic acid.

Examples of the multivalent hydroxy compound include: glycols such as ethylene glycol, diethylene glycol, triethylene glycol, and propylene glycol; alicyclic compounds including two hydroxyl groups such as 1,4-bis(hydroxymethyl)-cyclohexane; and dihydric phenol compounds such as bisphenol A. Note that, the multivalent hydroxy compound also includes compounds having three or more hydroxyl groups.

Examples of the polybasic acid include: dicarboxylic acids such as maleic acid, fumaric acid, phthalic acid, isophthalic acid, terephthalic acid, succinic acid, and malonic acid; and multivalent carboxylic acids that are trivalent or higher, such as 1,2,4-benzene tricarboxylic acid, 1,2,5-benzene tricarboxylic acid, 1,2,4-cyclohexane tricarboxylic acid, 1,2,4-naphthalene tricarboxylic acid, 1,2,5-hexane tricarboxylic acid, 1,3-dicarboxyl-2-methylenecarboxypropane, and 1,2,7,8-octanetetracarboxylic acid. These may be used alone or in combination.

Examples of the raw material monomers of polyester, polyamide, and polyester⋅polyamide that are resins obtained through polycondensation reaction include, as monomers forming an amide component, polyamines such as ethylenediamine, pentamethylenediamine, hexamethylenediamine, phenylenediamine, and triethylenetetramine; and aminocarboxylic acids such as 6-aminocaproic acid and ε-caprolactam, in addition to the aforementioned monomer raw materials. These may be used alone or in combination.

A glass transition temperature (Tg) of the resin obtained through polycondensation reaction is preferably 55 degrees Celsius or more, more preferably 57 degrees Celsius or more, in terms of thermal stability.

The resin obtained through addition polymerization reaction is not particularly limited and may be appropriately selected depending on the intended purpose. Specific examples thereof include vinyl-based resins obtained through radical polymerization.

Examples of the raw material monomers of the addition-polymerization-based resins include: styrene, o-methylstyrene, m-methylstyrene, p-methylstyrene, α-methylstyrene, p-ethylstyrene, and vinylnaphthalene; ethylenically unsaturated monoolefins such as ethylene, propylene, butylene, and isobutylene; vinyl esters such as vinyl chloride, vinyl bromide, vinyl acetate, and vinyl formate; ethylenically monocarboxylic acids and esters thereof (e.g., acrylic acid, methyl acrylate, ethyl acrylate, n-propyl acrylate, isopropyl acrylate, tert-butyl acrylate, amyl acrylate, methacrylic acid, methyl methacrylate, ethyl methacrylate, n-propyl methacrylate, isopropyl methacrylate, tert-butyl methacrylate, amyl methacrylate, stearyl methacrylate, methoxyethyl methacrylate, glycidyl methacrylate, phenyl methacrylate, dimethylaminoethyl methacrylate, and diethylaminoethyl methacrylate); ethylenically monocarboxylic acid substituted products such as acrylonitrile, methacrylonitrile, and acryl amide; ethylenically dicarboxylic acid or substituted products thereof such as dimethyl maleate; and vinyl ketones such as methyl vinyl ketone. These may be used alone or in combination.

A cross-linking agent can be added to the raw material monomer of the aforementioned addition-polymerization-based resin if necessary.

The cross-linking agent is not particularly limited and may be appropriately selected depending on the intended purpose. Examples thereof include divinylbenzene, divinylnaphthalene, polyethylene glycol dimethacrylate, diethylene glycol dimethacrylate, triethylene glycol diacrylate, dipropylene glycol dimethacrylate, polypropylene glycol dimethacrylate, and diallyl phthalate. These may be used alone or in combination.

An amount of the cross-linking agent is preferably 0.05 parts by mass or more but 15 parts by mass or less, more preferably 0.1 parts by mass or more but 10 parts by mass or less, relative to 100 parts by mass of the raw material monomer of the addition-polymerization-based resin. When the amount of the cross-linking agent is 0.05 parts by mass or more, an effect achieved by addition of the cross-linking agent can be obtained. When the amount of the cross-linking agent is 15 parts by mass or less, melting by application of heat is facilitated and fixing of the toner is good when heat is used for fixing.

When the raw material monomer of the addition-polymerization-based resin is allowed to polymerize, a polymerization initiator is preferably used. The polymerization initiator is not particularly limited and may be appropriately selected depending on the intended purpose. Examples thereof include: azo- or diazo-polymerization initiators such as 2,2′-azobis(2,4-dimethylvaleronitrile) and 2,2′-azobisisobutyronitrile; and peroxide polymerization initiators such as benzoyl peroxide, methyl ethyl ketone peroxide, and 2,4-dichlorobenzoyl peroxide. These may be used alone or in combination.

An amount of the polymerization initiator is preferably 0.05 parts by mass or more but 15 parts by mass or less, more preferably 0.5 parts by mass or more but 10 parts by mass or less, relative to 100 parts by mass of the raw material monomer of the addition-polymerization-based resin.

In the polycondensation reaction or the addition polymerization reaction described above, the polymer obtained may be a non-linear polymer having a non-linear structure or may be a linear polymer having a linear structure depending on a difference of reaction materials etc.

In the present disclosure, both a non-linear polymer (A) and a linear polymer (B) can be used.
The non-linear polymer means a polymer that has a substantial cross-linking structure, and the linear polymer means a polymer that does not substantially have a cross-linking structure.

In the present disclosure, a hybrid resin, which is obtained by chemically binding a polycondensation-based resin and an addition-polymerization-based resin, is obtained. Therefore, a compound reactive to the polycondensation-based resin and the addition-polymerization-based resin, which can react with the monomers of both resins, is preferably used for polymerization.

Examples of the compound reactive to the polycondensation-based resin and the addition-polymerization-based resin include fumaric acid, acrylic acid, methacrylic acid, maleic acid, and dimethyl fumarate.

An amount of the compound reactive to the polycondensation-based resin and the addition-polymerization-based resin used is preferably 1 part by mass or more but 25 parts by mass or less, more preferably 2 parts by mass or more but 10 parts by mass or less, relative to 100 parts by mass of the raw material monomer of the addition-polymerization-based resin. When the amount of the compound reactive to the polycondensation-based resin and the addition-polymerization-based resin used is 1 part by mass or more, dispersion of a colorant or a charging-controlling agent is good, which makes it possible to achieve high image quality. In addition, when the amount of the compound reactive to the polycondensation-based resin and the addition-polymerization-based resin used is 25 parts by mass or less, the resin does not change into gel, which is advantageous.

Regarding the hybrid resin, it is not necessary to allow two reactions to proceed and finish simultaneously, and progress of the reactions can be independently finished by each selecting a reaction temperature and time. For example, the following method is provided. Specifically, a mixture including an addition-polymerization-based raw material monomer of a vinyl-based resin and a polymerization initiator is added dropwise to a mixture including a polycondensation-based raw material monomer of a polyester resin in a reaction vessel, followed by mixing in advance. First, polymerization reaction of the vinyl-based resin is allowed to finish through radical reaction, and then polycondensation reaction of the polyester resin is allowed to finish through polycondensation reaction by increasing the reaction temperature.

According to the aforementioned method, two independent reactions can proceed simultaneously in a reaction vessel, and two resins can be effectively dispersed.

As the resin, a resin other than the aforementioned resin can be used in combination so long as it adversely affects performance of the toner. Such a resin is not particularly limited and may be appropriately selected depending on the intended purpose. Examples thereof include polyurethane resins, silicone resins, ketone resins, petroleum-based resins, and hydrogenated petroleum-based resins. These may be used alone or in combination.

<<Other Components>>

The other components are not particularly limited and may be appropriately selected depending on the intended purpose. Examples thereof include colorants, charging-controlling agents, fluidity-improving agents, cleaning-improving agents, and magnetic materials.

—Colorant—

The colorant is not particularly limited and may be appropriately selected depending on the intended purpose. Examples thereof include carbon black, a nigrosine dye, iron black, naphthol yellow S, Hansa yellow (10G, 5G, G), cadmium yellow, yellow iron oxide, yellow ocher, yellow lead, titanium yellow, polyazo yellow, oil yellow, Hansa yellow (GR, A, RN, R), pigment yellow L, benzidine yellow (G, GR), permanent yellow (NCG), Vulcan fast yellow (5G, R), tartrazine lake, quinoline yellow lake, anthrasan yellow BGL, isoindolinon yellow, red iron oxide, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL, F4RH), fast scarlet VD, vulcan fast rubin B, brilliant scarlet G, lithol rubin GX, permanent red F5R, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS, BC), indigo, ultramarine, Prussian blue, anthraquinone blue, fast violet B, methyl violet lake, cobalt violet, manganese violet, dioxane violet, anthraquinone violet, chrome green, zinc green, viridian, emerald green, pigment green B, naphthol green B, green gold, acid green lake, malachite green lake, phthalocyanine green, anthraquinone green, titanium oxide, zinc flower, and lithopone.

An amount of the colorant is not particularly limited and may be appropriately selected depending on the intended purpose. The amount thereof is preferably 1 part by mass or more but 15 parts by mass or less, more preferably 3 parts by mass or more but 10 parts by mass or less, relative to 100 parts by mass of the toner.

The colorant can be used as masterbatch composited with a resin. Examples of the resin that is kneaded with the masterbatch used in a method for producing the masterbatch include: polymers of styrene (e.g., polystyrene, poly p-chlorostyrene, and polyvinyltoluene) or a substituted product thereof; styrene-based compolymers such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-methyl chloromethacrylate copolymer, styrene-acrylonitrile copolymer, styrene-methyl vinyl ketone copolymer, styrene-butadiene copolymer, styrene-isoprene copolymer, styreneacrylonitrile-indene copolymer, styrene-maleic acid copolymer, and styrene-malate copolymer; and polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic resin, rosin, modified rosin, terpene resin, aliphatic or alicyclic hydrocarbon resin, aromatic petroleum resin, chlorinated paraffin, and paraffin wax, in addition to amorphous polyester resins. These may be used alone or in combination.

The masterbatch can be obtained by mixing a resin for masterbatch and a colorant by application of high shearing force and then kneading them. At this time, in order to improve interaction between the colorant and the resin, an organic solvent can be used. Such a method that an aqueous paste containing water of a colorant is mixed and kneaded with a resin and an organic solvent and the colorant is transferred to a side of the resin to thereby remove the water content and the organic solvent content (a socalled flushing method) is preferably used because a wet cake of the colorant can be directly used and is not required to be dried. In order to perform mixing and kneading, a highly shearing-dispersing apparatus such as a three-roll mill is preferably used.

—Charging-Controlling Agent—

The charging-controlling agent is not particularly limited and may be appropriately selected depending on the intended purpose. Examples thereof include nigrosin-based dyes, triphenylmethane-based dyes, chrome-containing metal complex dyes, molybdic acid chelate pigments, rhodamine-based dyes, alkoxy-based amine, quaternary ammonium salts (including fluorine-modified quaternary ammonium salts), alkylamide, simple substance or compounds of phosphorous, simple substance or compounds of tungsten, fluorine-based activators, metal salts of salicylic acid, and metal salts of salicylic acid derivatives.

Specific examples thereof include BONTRON 03 that is a nigrosin-based dye, BONTRON P-51 that is a quaternary ammonium salt, BONTRON S-34 that is a metalcontaining azo dye, E-82 that is an oxynaphthoic acid-based metal complex, E-84 that is a salicylic acid-based metal complex, and E-89 that is a phenol-based condensate (all of them are available from ORIENT CHEMICAL INDUSTRIES CO., LTD.), TP-302 and TP-415 that are quaternary ammonium salt molybdenum complexes (both of them are available from Hodogaya Chemical Co., Ltd.), LRA-901, LR-147 that is a boron complex (available from Japan Carlit Co., Ltd.), copper phthalocyanine, perylene, Quinacridone, azo-pigments, and other polymer-based compounds having, for example, a functional group such as a sulfonate group, a carboxyl group, or a quaternary ammonium salt.

An amount of the charging-controlling agent is not particularly limited and may be appropriately selected depending on the intended purpose. The amount thereof is preferably 0.1 parts by mass or more but 10 parts by mass or less, more preferably 0.2 parts by mass or more but 5 parts by mass or less, relative to 100 parts by mass of the toner. When the amount thereof is 10 parts by mass or less, a charging property of the toner becomes appropriate, and an effect achieved by addition of the charging-controlling agent is good, electrostatic attraction force with a developing roller is appropriate, and fluidity of the developer becomes good, which makes it possible to obtain high image density. These charging-controlling agents can be melted and kneaded together with a masterbatch and a resin, followed by dissolving and dispersing them, or may be directly added to an organic solvent when dissolved and dispersed. These charging-controlling agents may be fixed on the surface of toner after toner particles are prepared.

—Fluidity-Improving Agent—

The fluidity-improving agent is not particularly limited and may be appropriately selected depending on the intended purpose, so long as it gives a surface treatment to increase hydrophobicity and can prevent deterioration of the flow characteristic and the charging characteristic even under a high humidity condition. Examples thereof include silane coupling agents, silylating agents, silane coupling agents having a fluorinated alkyl group, organic-titanate-based coupling agents, aluminum-based coupling agents, silicone oil, and modified silicone oil. Particularly preferably, the silica and the titanium oxide are subjected to a surface treatment using the above-described fluidity-improving agent and are used as a hydrophobic silica and a hydrophobic titanium oxide, respectively.

—Cleaning-Improving Agent—

The cleaning-improving agent is not particularly limited and may be appropriately selected depending on the intended purpose, so long as it is added to the toner in order to remove a developer remaining on a photoconductor or a primary transfer medium after transfer. Examples thereof include: metallic salts of fatty acids such as zinc stearate, calcium stearate, and stearic acid; and polymer particles produced through soap-free emulsion polymerization such as polymethyl methacrylate particles and polystyrene particles. The polymer particles preferably have a relatively narrow particle size distribution, and those having a volume average particle diameter of 0.01 micrometers or more but 1 micrometer or less are suitable.

—Magnetic Material—

The magnetic material is not particularly limited and may be appropriately selected depending on the intended purpose. Examples thereof include iron powder, magnetite, and ferrite. Among them, a white magnetic material is preferable in terms of color tone.

A method for producing the toner of the present disclosure is not particularly limited and may be appropriately selected depending on the intended purpose. The toner is produced in the following manner, for example. A resin, a colorant, a release agent, and other components if necessary are mixed using a mixer and are kneaded using a kneader such as a heat roller or an extruder. Then, the resultant is cooled and solidified, and is pulverized using a pulverizing machine such as a jet mill. After that, the pulverized product is classified to obtain toner base particles. The obtained toner base particles and the inorganic particles are mixed to produce a toner.

Note that, the method for producing the toner is not particularly limited, and any of bulk polymerization, solution polymerization, emulsion polymerization, suspension polymerization can be used.

(Toner Stored Container)

A toner stored container of the present disclosure is a container storing a toner.

By forming an image using an image forming apparatus in which the toner stored container of the present disclosure is mounted, it is possible to prevent occurrence of an image having fog under a low-temperature and low-humidity environment (temperature of 10 degrees Celsius and humidity of 15% RH) over time, and to form an image obtained by utilizing the characteristics of the toner that can achieve high image density.

(Developer)

A developer of the present disclosure includes the toner of the present disclosure and a carrier.

The carrier is not particularly limited and may be appropriately selected depending on the intended purpose. However, a carrier including a core material and a resin layer coating the core material is preferable.

A material of the core material is not particularly limited and may be appropriately selected from known materials. For example, manganese-strontium (Mn—Sr)-based materials and manganese-magnesium (Mn—Mg)-based materials of from 50 emu/g to 90 emu/g are preferable. In terms of ensuring image density, highly magnetized materials such as iron powder (100 emu/g or more) and magnetite (from 75 emu/g to 120 emu/g) are preferable. Furthermore, low magnetized materials such as copper-zinc (Cu—Zn)-based materials (from 30 emu/g to 80 emu/g) are preferable because such materials can alleviate an impact on a photoconductor where the toner is in the form of magnetic brush, and are advantageous for improving image quality. These may be used alone or in combination.

A particle diameter of the core material is preferably 10 micrometers or more but 200 micrometers or less, more preferably 40 micrometers or more but 100 micrometers or less, in terms of an average particle diameter (volume average particle diameter (D₅₀)).

A material of the resin layer is not particularly limited and may be appropriately selected from known resins depending on the intended purpose. Examples thereof include amino-based resins, polyvinyl-based resins, polystyrene-based resins, halogenated olefin resins, polyester-based resins, polycarbonate-based resins, polyethylene resins, polyvinyl fluoride resins, polyvinylidene fluoride resins, polytrifluoroethylene resins, polyhexafluoropropylene resins, compolymers of vinylidene fluoride and acryl monomer, compolymers of vinylidene fluoride and vinyl fluoride, fluoroterpolymers such as terpolymers of tetrafluoroethylene, vinylidene fluoride, and non-fluorinated monomer, and silicone resins. These may be used alone or in combination.

Examples of the amino-based resin include urea-formaldehyde resins, melamine resins, benzoguanamine resins, urea resins, polyamide resins, and epoxy resins. Examples of the polyvinyl-based resin include acrylic resins, polymethyl methacrylate resins, polyacrylonitrile resins, polyvinyl acetate resins, polyvinyl alcohol resins, and polyvinyl butyral resins. Examples of the polystyrene-based resin include polystyrene resins and styrene-acryl copolymer resins. Examples of the halogenated olefin resin include polyvinyl chloride. Examples of the polyester-based resin include polyethylene terephthalate resins and polybutylene terephthalate resins.

The resin layer may include, for example, conductive powder if necessary. Examples of the conductive powder include metal powder, carbon black, titanium oxide, tin oxide, and zinc oxide. These conductive powders preferably have an average particle diameter of 1 micrometer or less. The average particle diameter satisfying 1 micrometer or less is advantageous because electric resistance can be easily controlled.

The resin layer can be formed in the following manner. Specifically, the silicone resin and the like is dissolved in a solvent to prepare a coating solution. Then, the coating solution is uniformly coated on the surface of the core material through a known coating method. The resultant is dried and then baked to form the resin layer. Examples of the coating method include the dipping method, the spraying method, and the brush coating method.

The solvent is not particularly limited and may be appropriately selected depending on the intended purpose. Examples thereof include toluene, xylene, methyl ethyl ketone, methyl isobutyl ketone, and butyl cellosolve acetate.
The baking is not particularly limited and may be an external heating system or an internal heating system. Examples of the baking include methods using a fixed-type electric furnace, a flow-type electric furnace, a rotary-type electric furnace, and a burner furnace, and methods using microwave.

An amount of the resin layer in the carrier is preferably 0.01% by mass or more but 5.0% by mass or less.

When the amount thereof is 0.01% by mass or more, the resin layer can be uniformly formed on the surface of the core material. When the amount thereof is 5.0% by mass or less, a thickness of the resin layer is appropriate, which makes it possible to obtain uniform carrier particles.

An amount of the carrier in a two-component developer is not particularly limited and may be appropriately selected depending on the intended purpose. For example, the amount thereof is preferably 90% by mass or more but 98% by mass or less, more preferably 93% by mass or more but 97% by mass or less.

A mixing ratio between the toner and the carrier in the two-component developer is preferably 1 part by mass or more but 10.0 parts by mass or less of the toner relative to 100 parts by mass of the carrier.

The developer of the present disclosure includes the toner of the present disclosure. Therefore, occurrence of an image having fog over time under a low-temperature and low-humidity environment can be prevented and high image density can be achieved.

The developer of the present disclosure can be suitably used for forming an image through various electrophotography methods, and can be particularly suitably used in a developing device, a process cartridge, an image forming apparatus, and an image forming method of the present disclosure, which will be described hereinafter.

(Developing Apparatus)

A developing device of the present disclosure is an apparatus including: a developer; and a developer bearer configured to convey the developer while the developer bearer bears the developer. The developing device is configured to form an electric field in a position facing an electrostatic latent image bearer, and develop, using the developer, an electrostatic latent image formed on the electrostatic latent image bearer to form a visible image.

The developer is the developer of the present disclosure.

(Process Cartridge)

A process cartridge of the present disclosure at least includes an electrostatic latent image bearer configured to bear an electrostatic latent image; and a developing unit configured to develop, using a developer, the electrostatic latent image born on the electrostatic latent image bearer to form a visible image, and further includes other units appropriately selected depending on the intended purpose.

The developing unit includes at least a developer stored container storing the toner or the developer of the present disclosure, and a developer bearer configured to bear and convey the toner or the developer stored in the developer stored container, and may further include, for example, a layer thickness regulating member configured to regulate a thickness of the toner to be born.
The process cartridge of the present disclosure can be detachably mounted in various image forming apparatuses, and is preferably detachably mounted in an image forming apparatus of the present disclosure that will be described hereinafter.

The toner of the present disclosure can achieve excellent effects even when it is loaded into an image forming apparatus including a process cartridge to form an image. That is, a process cartridge that makes image quality excellent can be provided by using the toner of the present disclosure.

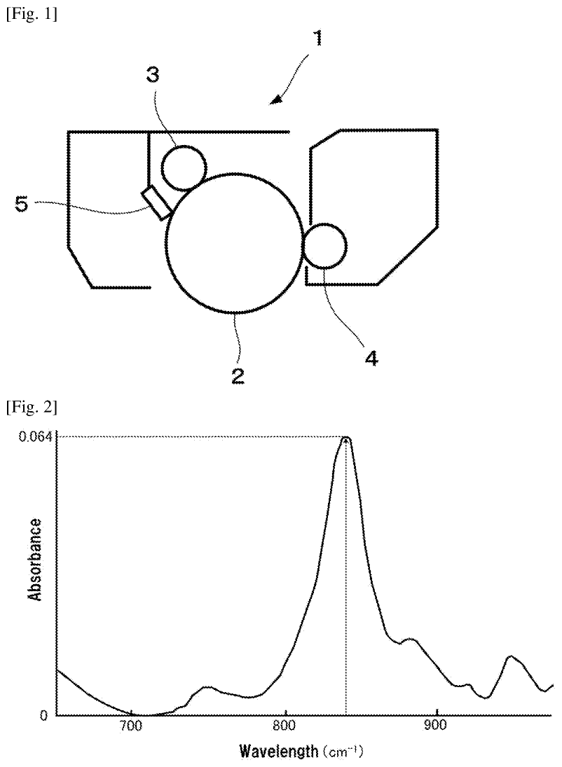

FIG. 1 is a schematic diagram presenting one example of a process cartridge of the present disclosure. A process cartridge 1 of FIG. 1 includes a photoconductor 2, a charging unit 3, a developing unit 4, and a cleaning unit 5.

In an image forming apparatus including the process cartridge, the photoconductor 2 is rotated and driven at a predetermined circumferential speed.

In the rotation process, the photoconductor 2 bears uniformly positive or negative charges having a predetermined electric potential around the peripheral surface by the charging unit 3. Then, the photoconductor 2 is exposed to image-exposing light from an image-exposing unit such as slit exposure or laser beam scanning exposure to thereby subsequently form an electrostatic latent image around the peripheral surface of the photoconductor 2. The formed electrostatic latent image is then developed with a toner by the developing unit 4, and the developed toner image is subsequently transferred by a transfer unit on a recording medium, which is fed between the photoconductor and the transfer unit by a paper feeding unit in synchronization with rotation of the photoconductor.

The recording medium that has undergone the image transfer is separated from the surface of the photoconductor and is introduced into a fixing unit to fix the image. Then, it is printed out as a copied product (copy) into the outside of an apparatus.

On the surface of the photoconductor after the transfer, the remaining toner after the transfer is removed by the cleaning unit 5 for cleaning the surface thereof, and then electricity is further removed. Then, the photoconductor is repeatedly used for image formation.

When the toner of the present disclosure is also used in an image forming apparatus including a contact-type charging device for forming an image, an excellent effect can be achieved. That is, use of the toner of the present disclosure makes it possible to provide an image forming apparatus using a charging device that generates reduced ozone.

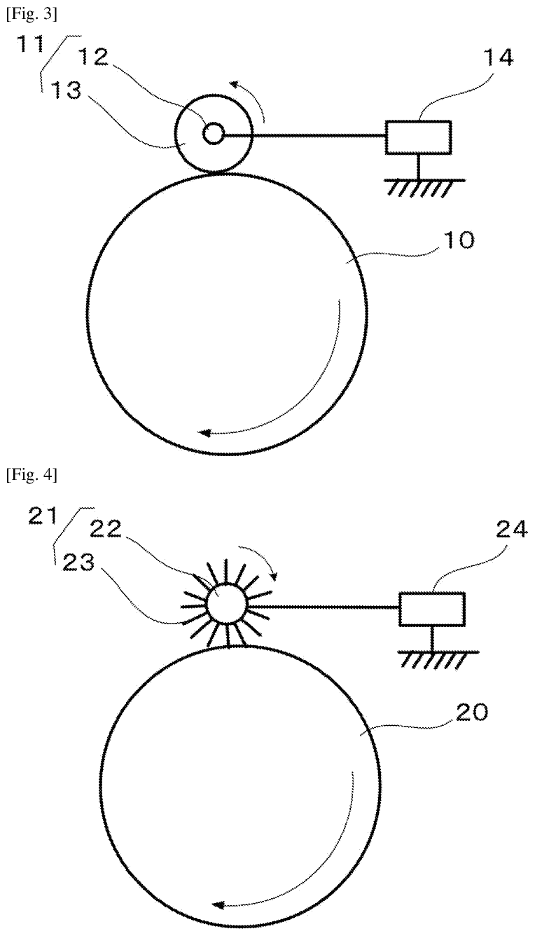

Here, FIG. 3 is a schematic diagram presenting one example of an image forming apparatus having a charging device configured to perform roller charging.

A drum-shaped photoconductor 10 as a body to be charged and an image bearer is rotated and driven at a predetermined speed (process speed) in a direction indicated by an arrow in FIG. 3.

A charging roller 11, which is a charging member provided in contact with the photoconductor 10, includes, as a basic structure, a cored bar 12 and an electric conductive rubber layer 13, which is formed on the peripheral surface of the cored bar 12 and is integrally and concentrically formed with the roller. The both ends of the cored bar 12 are rotatably supported with, for example, a bearing member that is not illustrated. Moreover, a pressurization unit (not illustrated) presses against the photoconductor drum at a predetermined pressing force. In the case of FIG. 3, the charging roller 11 is rotated in synchronization with the rotating and driving of the photoconductor 10.

The charging roller 11 is formed by coating, on the cored bar having a diameter of 9 mm, a rubber layer having an intermediate resistance of about 100,000 Ω·cm to give a diameter of 16 mm to the charging roller 11.

As presented in FIG. 3, the cored bar 12 of the charging roller 11 and a power source 14 are electrically connected, and a predetermined bias is applied to the charging roller 11 from the power source 14. As a result, the peripheral surface of the photoconductor 10 is uniformly charged so as to have predetermined polarity and potential.

FIG. 4 is a schematic diagram presenting one example of an image forming apparatus including a charging device configured to perform blush charging.

A drum-shaped photoconductor 20 as a body to be charged and an image bearer is rotated and driven at a predetermined speed (process speed) in a direction indicated by an arrow in FIG. 4.

The far brush roller 21 is brought into contact with the photoconductor 20 with a predetermined nip width with a predetermined pressing force being against elasticity of a brush part 23.

The far brush roller 21 as a contact charging member is a roll brush having an outer diameter of 14 mm and a longitudinal length of 250 mm, which is formed by spirally winding a tape, which is a terry of conductive rayon fibers REC-B (available from UNITIKA LTD.) as a brush part 23, around a metallic cored bar 22 having a diameter of 6 mm and also serving as an electrode.

The brush of the brush part 23 is, for example, 300 deniers/50 filaments, and has a density of 155 filaments/mm².

This roll brush is inserted into a pipe having an inner diameter of 12 mm with the roll brush being rotated in one direction, and is designed so that the pipe is concentric with the brush. Then, the roll brush is left to stand in a high temperature and high humidity atmosphere to make the fibers slanted.

The resistance value of the far brush roller 21 is 1×10⁵Ω at an application voltage of 100 V.

The resistance value is determined by converting electric current flowing when the far brush roller 21 abuts on a metallic drum having a diameter of 30 mm with a nip width of 3 mm, and then voltage of 100 V is applied thereto.

The resistance value of the fur brush charging device is preferably 104Ω or more, in order to prevent image failure due to charging failure at a charging nip, which is caused by running excessive leak current into a defect portion having a low voltage resistance such as pin holes on the photoconductor 20 as a body to be charged. Moreover, in order to sufficiently inject charges into the surface of the photoconductor, the resistance is more preferably 10⁷Ω or less.

Examples of the material of the brush include, other than REC-B (available from UNITIKA LTD.), REC-C, REC-M1, and REC-M10 (available from UNITIKA LTD.); SA-7 (available from Toray Industries, Inc.), Thunderon (available from Nihon Sanmo Dyeing Co., Ltd.), Belltron (available from Kanebo, Ltd.), Kuracarb (available from KURARY CO., LTD.), those obtained by dispersing carbon in rayon, and Roval (available from Mitsubishi Rayon Co., Ltd).

Preferably, each brush is from 3 deniers to 10 deniers/fiber, have 10 filaments/bundle to 100 filaments/bundle, and have a density of 80 fibers/mm² to 600 fibers/mm². The length of the fiber is preferably from 1 mm to 10 mm.

The far brush roller 21 is rotated and driven in the opposite direction (counter) to the rotational direction of the photoconductor 20 at a predetermined circumferential speed (speed of the surface), and is brought into contact with the surface of the photoconductor with a difference in the speeds. Then, when a predetermined charging voltage is applied to the far brush roller 21 from the power source 24, the surface of the photoconductor is uniformly charged in a contact manner so as to have predetermined polarity and potential.

The contact charging of the photoconductor 20 by the far brush roller 21 is dominantly performed with direct injection of charges, and the surface of the photoconductor is charged with the potential, which is substantially the same to the applied charging voltage to the far brush roller 21.

In the case of magnetic brush charging, the far brush roller 21 formed of the magnetic brush is brought into contact with the photoconductor 20 with a predetermined nip width with a predetermined pressing force being against elasticity of a brush part 23, similarly to the above fur brush charging.

As the magnetic brush as a contact charging member, used are magnetic particles prepared by mixing Zn—Cu ferrite particles having an average particle diameter of 25 micrometers and Zn—Cu ferrite particles having an average particle diameter of 10 micrometers at a mass ratio of 1:0.05, and then coating, with an intermediate resistance resin layer, the ferrite particles having an average particle diameter of 25 micrometers and having peaks at the aforementioned average particle diameters.
The contact charging member is composed of, for example, the coated magnetic particles prepared above, a non-magnetic electric conductive sleeve configured to support the coated magnetic particles, and a magnet roll provided inside the electric conductive sleeve. The coated magnetic particles are coated on the electric conductive sleeve to give a thickness of 1 mm, to thereby form a charging nip having a width of about 5 mm with respect to the photoconductor 20.
Moreover, a space between the electric conductive sleeve bearing the coated magnetic particles and the photoconductor is, for example, about 500 micrometers.
Moreover, the magnet roll is rotated so that the sleeve surface rubs in the opposite direction at twice as fast as the circumferential speed of the surface of the photoconductor. As a result, the photoconductor and the magnetic brush are uniformly brought into contact with each other.

### EXAMPLES

Hereinafter, the present disclosure will be described by way of Examples. However, the present disclosure should not be construed as being limited to these Examples.

In the following Examples, a softening temperature, a glass transition temperature, and a weight average molecular weight of a resin, and a median diameter of inorganic particles were measured as follows.

<Measurement of Softening Temperature (Tm) and Glass Transition Temperature (Tg) of Resin>

A softening temperature (Tm) was measured using a Koka-type flow tester (available from SHIMADZU CORPORATION) according to the method described in JIS K72101. A sample (1 cm³) was heated at a heating speed of 6 degrees Celsius/min while a load of 20 kg/cm² was applied thereto using a plunger so as to push a nozzle having a diameter of 1 mm and a length of 1 mm. Then, a plunger-descending quantity-temperature curve was drawn, and a height of the serpentine curve was h. Here, a softening point (Tm) of a temperature corresponding to h/2 (temperature at which a half of the resin was flown out).

The glass transition temperature (Tg) was obtained as follows. A sample was heated from room temperature (25 degrees Celsius) to 200 degrees Celsius at 10 degrees Celsius/min and then was cooled to room temperature at a cooling temperature of 10 degrees Celsius/min using a differential scanning calorimeter (DSC-60, available from SHIMADZU CORPORATION). In the measurement at 10 degrees Celsius/min of the heating, the glass transition temperature (Tg) was a portion of a curve corresponding to ½ of the height h between a base line equal to or lower than the glass transition temperature and a base line equal to or higher than the glass transition temperature.

<Weight Average Molecular Weight (Mw) of Resin>

A GPC measuring apparatus (HLC-8220GPC, available from Tosoh Corporation) and columns (TSKgel SuperHZM-H 15 cm triple, available from Tosoh Corporation) were used to measure a weight average molecular weight. Specifically, the columns were stabilized in a heat chamber of 40 degrees Celsius. Then, tetrahydrofuran (THF) was charged into the columns at a flow rate of 1 mL/min and a THF solution containing from 0.05% by mass to 0.6% by mass of a sample was injected thereinto in an amount of from 50 microliters to 200 microliters to thereby measure a weight average molecular weight of the sample. At this time, from a relationship between a count number and a logarithmic value of a calibration curve prepared using several monodispersed polystyrene standard samples, a number average molecular weight of the sample was measured.

Note that, as the standard polystyrene samples, samples having a weight average molecular weight of 6×10², 2.1×10³, 4×10³, 1.75×10⁴, 5.1×10⁴, 1.1×10⁵, 3.9×10⁵, 8.6×10⁵, 2×10⁶, and 4.48×10⁶ (available from Pressure Chemical and Tosoh Corporation) were used.

As a detector, an RI (refractive index) detector was used.

<Median Diameter of Inorganic Particles>

A median diameter of the inorganic particles was measured as follows.

(1) A sample (0.1 g) was sampled in a glass bottle and methanol (20 g) was added thereto, followed by stirring.

(2) The resultant was dispersed for 10 minutes in an ultrasonic dispersing apparatus to obtain a measurement sample.

(3) The sample in (2) was measured using a laser diffraction scattering-type particle size distribution measuring device (available from HORIBA, Ltd., LA-920) to determine a median diameter.

### Production Example 1 of Non-Linear Polyester Resin

—Production of non-linear polyester resin A—

A flask equipped with a stainless stirring rod, a flow-down-type condenser, a nitrogen gas introducing tube, and a thermometer was charged with fumaric acid (9.0 mol), trimellitic anhydride (3.5 mol), bisphenol A (2,2) propylene oxide (5.5 mol), and bisphenol A (2,2) ethylene oxide (3.5 mol). Then, the resultant was allowed to undergo polycondensation reaction while stirred at 230 degrees Celsius under a nitrogen atmosphere to thereby obtain a non-linear polyester resin A.

The non-linear polyester resin A obtained was found to have a softening point (Tm) of 145.1 degrees Celsius, a glass transition temperature (Tg) of 61.5 degrees Celsius, and a weight average molecular weight (Mw) of 82,000.

### Production Example 2 of Linear Polyester Resin

—Production of Linear Polyester Resin B—

A flask equipped with a stainless stirring rod, a flow-down-type condenser, a nitrogen gas introducing tube, and a thermometer was charged with terephthalic acid (7 mol), trimellitic anhydride (2.5 mol), bisphenol A (2,2) propylene oxide (5.5 mol), and bisphenol A (2,2) ethylene oxide (3.5 mol). Then, the resultant was allowed to undergo polycondensation reaction while stirred at 230 degrees Celsius under a nitrogen atmosphere to thereby obtain a linear polyester resin B.

The linear polyester resin B obtained was found to have a softening point (Tm) of 102.8 degrees Celsius, a glass transition temperature (Tg) of 61.2 degrees Celsius, and a weight average molecular weight (Mw) of 8,000.

### Production Example 1 of Hybrid Resin

—Production of hybrid resin C—

Styrene (18 mol) and butylmethacrylate (4.5 mol) as addition polymerization reaction monomers, and t-butyl hydroperoxide (0.35 mol) as a polymerization initiator were charged into a dropping funnel. Fumaric acid (9.0 mol) as an addition polymerization and polycondensation reactive monomer, trimellitic anhydride (3.5 mol), bisphenol A (2,2) propylene oxide (5.5 mol), bisphenol A (2,2) ethylene oxide (3.8 mol) as polycondensation reactive monomers, and dibutyltin oxide (58 mol) as an esterification catalyst were charged into a flask equipped with a stainless stirring rod, a flow-down-type condenser, a nitrogen gas introducing tube, and a thermometer, and were stirred at 138 degrees Celsius under a nitrogen atmosphere. Then, the resultant that had been obtained in advance by mixing addition polymerization-based materials was added dropwise thereto from the dropping funnel for 4 hours.

After completion, the resultant was matured for 6 hours with the temperature being maintained at 138 degrees Celsius, and was heated to 230 degrees Celsius for reaction to thereby obtain a hybrid resin C.

The hybrid resin C obtained was found to have a softening point (Tm) of 151.5 degrees Celsius and a glass transition temperature (Tg) of 62.1.

The hybrid resin C obtained had the following formulation: polyester resin (weight average molecular weight (Mw)=48,000)/styrene-acryl copolymer resin (weight average molecular weight (Mw)=190,000)=78/22 (mass ratio).

### Production Example 1 of Alumina Powder

Alumina powder having a BET specific surface area of 120 m²/g was charged into a reaction vessel. A mixture solution including 8 g of heptadecafluorode-cyltrimethoxysilane and 1.8 g of hexamethyldisilazane relative to 100 g of the alumina powder was sprayed while the alumina powder was stirred under a nitrogen atmosphere. Then, the resultant was heated and stirred at 220 degrees Celsius for 150 minutes, and then was cooled to thereby obtain a fluorine-containing alumina 1.

### Production Example 2 of Alumina Powder

Alumina powder having a BET specific surface area of 120 m²/g was charged into a reaction vessel. A mixture solution including 4 g of heptadecafluorode-cyltrimethoxysilane and 0.5 g of hexamethyldisilazane relative to 100 g of the alumina powder was sprayed while the alumina powder was stirred under a nitrogen atmosphere. Then, the resultant was heated and stirred at 220 degrees Celsius for 150 minutes, and then was cooled to thereby obtain a fluorine-containing alumina 2.

### Production Example 3 of Alumina Powder

Alumina powder having a BET specific surface area of 120 m²/g was charged into a reaction vessel. A mixture solution including 5 g of heptadecafluorode-cyltrimethoxysilane and 0.9 g of hexamethyldisilazane relative to 100 g of the alumina powder was sprayed while the alumina powder was stirred under a nitrogen atmosphere. Then, the resultant was heated and stirred at 220 degrees Celsius for 150 minutes, and then was cooled to thereby obtain a fluorine-containing alumina 3.

### Example 1

—Toner Materials—
Non-linear polyester resin A: 42 parts by mass
Linear polyester resin B: 45 parts by mass
Hybrid resin C: 13 parts by mass
Carbon black: 18 parts by mass
Charging-controlling agent (Spilon Black TR-H, available from Hodogaya Chemical Co., Ltd.): 2.5 parts by mass
Release agent (low-molecular-weight polypropylene, weight average molecular weight (Mw)=5,500): 2.5 parts by mass

The aforementioned toner materials were stirred and mixed using a Henschel mixer and were heated and melted at a temperature of from 125 degrees Celsius to 130 degrees Celsius for 40 minutes using a roll mill, followed by cooling to room temperature (25 degrees Celsius). The obtained kneaded product was pulverized and classified using a jet mill to thereby obtain toner base particles A having a volume average particle diameter of 7.0 micrometers and particle size distribution where particles of 5 micrometers or less were 35% by number.

Next, silica (R-972, available from Clariant (Japan) K.K., median diameter of 16 nm) (1.2 parts by mass) and the fluorine-containing alumina 1 (0.4 parts by mass) were added to the toner base particles A (100 parts by mass), and were mixed upon stirring using a Henschel mixer under the following mixing conditions of the inorganic particles. Then, particles having a large diameter were removed through a mesh to thereby obtain a toner 1.

—Mixing Conditions—
Frequency: 80 Hz
Time: 10 min

### Example 2

A toner 2 was obtained in the same manner as in Example 1 except that silica (R-972, available from Clariant (Japan) K.K., median diameter of 16 nm) (1.2 parts by mass) and the fluorine-containing alumina 1 (1.0 part by mass) were added to the toner base particles A (100 parts by mass) and the mixing conditions of the inorganic particles were changed as follows.

—Mixing Conditions—
Frequency: 90 Hz
Time: 15 min

### Example 3

A toner 3 was obtained in the same manner as in Example 1 except that silica (R-972, available from Clariant (Japan) K.K., median diameter of 16 nm) (1.2 parts by mass) and the fluorine-containing alumina 2 (1.0 part by mass) were added to the toner base particles A (100 parts by mass) and the mixing conditions of the inorganic particles were changed as follows.

—Mixing Conditions—
Frequency: 90 Hz
Time: 15 min

### Example 4

A toner 4 was obtained in the same manner as in Example 1 except that silica (R-972, available from Clariant (Japan) K.K., median diameter of 16 nm) (1.2 parts by mass) and the fluorine-containing alumina 3 (1.0 part by mass) were added to the toner base particles A (100 parts by mass) and the mixing conditions of the inorganic particles were changed as follows.

—Mixing Conditions—
Frequency: 85 Hz
Time: 13 min

### Example 5

A toner 5 was obtained in the same manner as in Example 1 except that the mixing conditions of the inorganic particles were changed as follows.

—Mixing Conditions—
Frequency: 82 Hz
Time: 12 min

### Comparative Example 1

A toner 12 was obtained in the same manner as in Example 1 except that silica (R-972, available from Clariant (Japan) K.K., median diameter of 16 nm) (1.2 parts by mass) and the fluorine-containing alumina 1 (0.3 parts by mass) were added to the toner base particles A (100 parts by mass) and the mixing conditions of the inorganic particles were changed as follows.

—Mixing Conditions—
Frequency: 80 Hz
Time: 10 min

### Comparative Example 2

A toner 13 was obtained in the same manner as in Example 1 except that silica (R-972, available from Clariant (Japan) K.K., median diameter of 16 nm) (1.2 parts by mass) and the fluorine-containing alumina 2 (1.2 parts by mass) were added to the toner base particles A (100 parts by mass) and the mixing conditions of the inorganic particles were changed as follows.

—Mixing Conditions of Inorganic Particles—
Frequency: 90 Hz
Time: 15 min

### Comparative Example 3

A toner 14 was obtained in the same manner as in Example 1 except that silica (R-972, available from Clariant (Japan) K.K., median diameter of 16 nm) (1.2 parts by mass) and the fluorine-containing alumina 1 (0.3 parts by mass) were added to the toner base particles A (100 parts by mass) and the mixing conditions of the inorganic particles were changed as follows.

—Mixing Conditions—
Frequency: 60 Hz
Time: 5 min

### Comparative Example 4

A toner 15 was obtained in the same manner as in Example 1 except that silica (R-972, available from Clariant (Japan) K.K., median diameter of 16 nm) (1.2 parts by mass) and the fluorine-containing alumina 2 (1.2 parts by mass) were added to the toner base particles A (100 parts by mass) and the mixing conditions of the inorganic particles were changed as follows.

—Mixing Conditions—
Frequency: 100 Hz
Time: 25 min

### Comparative Example 5

A toner 16 was obtained in the same manner as in Example 1 except that the fluorine-containing alumina 1 was changed to fluorine-containing strontium titanate.

### Example 6

<Toner Materials>
Non-linear polyester resin A: 45 parts by mass
Linear polyester resin B: 42 parts by mass
Hybrid resin C: 13 parts by mass
Carbon black: 18 parts by mass
Charging-controlling agent (Spilon Black TR-H, available from Hodogaya Chemical Co., Ltd.): 2.5 parts by mass
Release agent (low-molecular-weight polypropylene, weight average molecular weight (Mw)=5,500): 2.6 parts by mass

The aforementioned mixture including the aforementioned materials was stirred and mixed using a Henschel mixer and was heated and melted at a temperature of from 125 degrees Celsius to 130 degrees Celsius for 40 minutes using a roll mill, followed by cooling to room temperature (25 degrees Celsius). The obtained kneaded product was pulverized and classified using a jet mill to thereby obtain toner base particles B having a volume average particle diameter of 7.0 micrometers and particle size distribution where particles of 5 micrometers or less were 35% by number.

Next, a toner 6 was prepared in the same manner as in Example 1 except that the toner base particles A were changed to the toner base particles B.

### Example 7

A toner 7 was obtained in the same manner as in Example 6 except that an amount of the low-molecular-weight polypropylene (weight average molecular weight (Mw)=5,500) as a release agent was changed from 2.6 parts by mass to 5.0 parts by mass.

### Example 8

A toner 8 was obtained in the same manner as in Example 2 except that silica (R-972, available from Clariant (Japan) K.K., median diameter of 16 nm) (1.2 parts by mass), the fluorine-containing alumina 1 (1.0 part by mass), and silicon oxide having a large particle diameter (median diameter of 55 nm) (0.5 parts by mass) were added to the toner base particles A (100 parts by mass).

### Example 9

A toner 9 was obtained in the same manner as in Example 8 except that the silicon oxide having a large particle diameter (median diameter of 55 nm) was changed to silicon oxide having a large particle diameter (median diameter of 320 nm).

### Example 10

A toner 10 was obtained in the same manner as in Example 8 except that the silicon oxide having a large particle diameter (median diameter of 55 nm) was changed to silicon oxide having a large particle diameter (median diameter of 60 nm).

### Example 11

A toner 11 was obtained in the same manner as in Example 8 except that the silicon oxide having a large particle diameter (median diameter of 55 nm) was changed to silicon oxide having a large particle diameter (median diameter of 300 nm).

<Measurement Method of Concentration of Aluminum X1 and Concentration of Fluorine X2 Through XPS Method>
Analysis apparatus: X-ray photoelectron spectroscopic analysis apparatus, AXIS-ULTRA (available from SHIMADZU CORPORATION)
X-ray: 15 kV, 9 mA, Hybrid
Neutralizer gun: 2.0 A (F-Current), 1.3 V (F-Bias), 1.8 V (C-Balance)
Step: 0.1 eV (Narrow), 2.0 eV (Wide)
PassE: 20 eV (Narrow), 160 eV (Wide)
Relative sensitivity factor: Relative sensitivity factor of CasaXPS is used.
Preparation method of sample

The toner sample was loaded into a chip formed of Al, which is an accessory of an apparatus and has a cylindrical dent having a depth of 0.3 mm and a diameter of 4 mm, and the plane portion of the surface was measured.

Based on the analysis apparatus and the measurement conditions described above, the aforementioned sample was measured for a concentration of aluminum X1 and a concentration of fluorine X2 existing on the outermost layer of the toner through the X-ray photoelectron spectroscopic analysis (XPS) method, and a ratio (X1/X2) was determined. The unit of X1 and X2 is Atomic %. Results were presented in Table 1.

<Measurement Method of Peak Intensity Ratio (W/R)>

The peak intensity ratio (W/R) was calculated when a peak height of a characteristic spectrum of the release agent (wax) was W and a peak height of a characteristic spectrum of the resin was R from absorbance spectra measured through an ATR (attenuated total reflection) method using FT-IR (Fourier transform infrared spectroscopy analysis measurement device, Avatar 370, available from Thermo Electron). Because a smooth surface was required in the ATR method, the toner was subjected to compression and molding to form a smooth surface. In the compression and molding at this time, a load (1 t) was applied to the toner (2.0 g) for 60 seconds to obtain a pellet having a diameter of 20 mm.

W was a peak height of a characteristic spectrum (peak observed from 2834 cm⁻¹ to 2862 cm⁻¹) derived from C—H stretching of an alkyl chain from the wax, and R was a peak height of a characteristic spectrum of a resin (for example, in the case of a polyester resin, see FIG. 2, a peak observed from at 784 cm⁻¹ to 889 cm⁻¹; and in the case of a styrene-acrylic copolymer resin, a peak observed from at 670 cm⁻¹ to 714 cm⁻¹). The W/R was calculated as a peak intensity ratio. When two or more resins were mixed and two or more peaks were detected, the highest peak was used. In this Example, a polyester resin and a styrene-acrylic copolymer resin were included. However, an amount of the polyester resin was higher and its perk was higher. Therefore, a peak of the polyester resin was employed.

The peak intensity ratio (W/R) was obtained by converting a spectrum to absorbance and then using its peak height.

<Preparation of Developer>

Each toner (5% by mass) prepared and a copper-zinc ferrite carrier (95% by mass), which had an average particle diameter of 40 micrometers and was coated with a silicone resin, were mixed to thereby prepare each two-component developer.

<Image Evaluation>

Each two-component developer obtained was used to perform developing using a copying-machine (Imagio MF7070, available from Ricoh Company, Ltd.)-modified machine. After output was performed under the following conditions: low-temperature and low-humidity environment (temperature of 10 degrees Celsius and humidity of 15% RH); 5,000 sheets/day; initial; 100 K (100,000 sheets of paper). Then, three white solid images and three black solid images were printed on paper having a size of A3 (product: RICOH MyPaper, available from Ricoh Company, Ltd.). Then, fog on the solid image obtained was visually observed and was evaluated based on the following evaluation criteria of fog.

In addition, the image density (ID) of the solid image was measured using X-Rite938 (available from X-RITE) and was evaluated based on the following evaluation criteria of image density. Results were presented in Table 1.

—Evaluation Criteria of Fog—

A: No fog was found at all. Very good.

B: Almost no fog was found. Good.

C: Fog was found. Bad.

—Evaluation Criteria of Image Density—

A: The image density (ID) was less than 0.20.

B: The image density (ID) was 0.20 or more but less than 0.40.

C: The image density (ID) was 0.40 or more.

TABLE 1

| | | | Inorganic particles | | | | | |
|---|---|---|---|---|---|---|---|---|
| | | | Fluorine- | | | | | |
| | | | containing | | Silicon oxide having | | | |
| | | | alumina | | large particle diameter | | | |
| | | Kind of | | Amount | | Amount | Silica (R-972) | |
| | | toner | | (parts | Median | (parts | Median | Amount |
| | Toner | base | | by | diameter | by | diameter | (parts by |
| TABLE 1 | No. | particles | Kind | mass) | (nm) | mass) | (nm) | mass) |
| Example 1 | 1 | A | 1 | 0.4 | — | — | 16 | 1.2 |
| Example 2 | 2 | A | 1 | 1.0 | — | — | 16 | 1.2 |
| Example 3 | 3 | A | 2 | 1.0 | — | — | 16 | 1.2 |
| Example 4 | 4 | A | 3 | 1.0 | — | — | 16 | 1.2 |
| Example 5 | 5 | A | 1 | 0.4 | — | — | 16 | 1.2 |
| Example 6 | 6 | B | 1 | 0.4 | — | — | 16 | 1.2 |
| Example 7 | 7 | C | 1 | 0.4 | — | — | 16 | 1.2 |
| Example 8 | 8 | A | 1 | 1.0 | 55 | 0.5 | 16 | 1.2 |
| Example 9 | 9 | A | 1 | 1.0 | 320 | 0.5 | 16 | 1.2 |
| Example 10 | 10 | A | 1 | 1.0 | 60 | 0.5 | 16 | 1.2 |
| Example 11 | 11 | A | 1 | 1.0 | 300 | 0.5 | 16 | 1.2 |
| Comparative | 12 | A | 1 | 0.3 | — | — | 16 | 1.2 |
| Example 1 | | | | | | | | |
| Comparative | 13 | A | 2 | 1.2 | — | — | 16 | 1.2 |
| Example 2 | | | | | | | | |
| Comparative | 14 | A | 1 | 0.3 | — | — | 16 | 1.2 |
| Example 3 | | | | | | | | |
| Comparative | 15 | A | 2 | 1.2 | — | — | 16 | 1.2 |
| Example 4 | | | | | | | | |
| Comparative | 16 | A | — | — | — | — | 16 | 1.2 |
| Example 5 | | | | | | | | |

TABLE 2

Evaluation results

| | | | | | Image |
|---|---|---|---|---|---|
| | | | Ratio | | density |
| | X1 | X1/X2 | (W/R) | Fog | (ID) |
| Example 1 | 2.1 | 2.7 | 0.04 | B | B |
| Example 2 | 3.0 | 3.1 | 0.04 | B | B |
| Example 3 | 3.0 | 5.5 | 0.04 | B | B |
| Example 4 | 2.9 | 5.2 | 0.04 | A | B |
| Example 5 | 2.1 | 2.8 | 0.04 | A | B |
| Example 6 | 2.1 | 2.7 | 0.05 | A | A |
| Example 7 | 2.1 | 2.7 | 0.14 | A | A |
| Example 8 | 2.1 | 2.7 | 0.04 | A | B |
| Example 9 | 2.1 | 2.7 | 0.04 | A | B |
| Example 10 | 2.1 | 2.7 | 0.04 | A | A |
| Example 11 | 2.1 | 2.7 | 0.04 | A | A |
| Comparative | 2.0 | 2.7 | 0.04 | B | C |
| Example 1 | | | | | |
| Comparative | 3.1 | 5.5 | 0.04 | C | B |
| Example 2 | | | | | |
| Comparative | 2.3 | 2.5 | 0.04 | C | C |
| Example 3 | | | | | |
| Comparative | 2.9 | 5.8 | 0.04 | C | B |
| Example 4 | | | | | |
| Comparative | 0 | 0 | 0.04 | C | B |
| Example 5 | | | | | |

Aspects of the present disclosure are as follows, for example.
<1> A toner including
inorganic particles,
wherein the inorganic particles include a fluorine-containing alumina, and
the toner satisfies both Formula (1) below and Formula (2) below:

2.7≤X1/X2≤5.5 Formula (1); and

2.1≤X1≤3.0 Formula (2)

where X1 denotes a concentration of aluminum in the toner and X2 denotes a concentration of fluorine in the toner, and the concentration of aluminum and the concentration of fluorine are determined through an X-ray photoelectron spectroscopic analysis method.
<2> The toner according to <1>,
wherein the toner satisfies both Formula (3) below and Formula (4) below:

2.8≤X1/X2≤5.2 Formula (3); and

2.1≤X1≤2.9 Formula (4)

where X1 denotes the concentration of aluminum in the toner and X2 denotes the concentration of fluorine in the toner, and the concentration of aluminum and the concentration of fluorine are determined through the X-ray photoelectron spectroscopic analysis method.
<3> The toner according to <1> or <2>, further including:
a release agent; and
a resin,
wherein the toner satisfies a ratio (W/R) of 0.05 or more but 0.14 or less where W denotes a peak height of a characteristic spectrum of the release agent and R denotes a peak height of a characteristic spectrum of the resin, and the peak height of the characteristic spectrum of the release agent and the peak height of the characteristic spectrum of the resin are measured through an attenuated total reflection method using Fourier transform infrared spectroscopy analysis measurement device.
<4> The toner according to any one of <1> to <3>,
wherein the inorganic particles further include inorganic particles other than the fluorine-containing alumina, and
a median diameter of the inorganic particles other than the fluorine-containing alumina is 60 nm or more but 300 nm or less.
<5> A toner stored container including:
the toner according to any one of <1> to <4>; and
a container,
the toner being stored in the container.
<6> A developer including:
the toner according to any one of <1> to <4>; and
a carrier.
<7> A developing device including:
the developer according to <6>; and
a developer bearer configured to convey the developer while the developer bearer bears the developer,
wherein the developing device is configured to form an electric field in a position facing an electrostatic latent image bearer, and develop, using the developer, an electrostatic latent image formed on the electrostatic latent image bearer to form a visible image.
<8> A process cartridge including:
an electrostatic latent image bearer; and
a developing unit including the developing device according to <7> and configured to develop, using the developer, an electrostatic latent image formed on the electrostatic latent image bearer to form a visible image, the process cartridge being detachably mounted in a body of an image forming apparatus.
<9> An image forming apparatus including:
an electrostatic latent image bearer;
a charging unit configured to charge a surface of the electrostatic latent image bearer;
an exposing unit configured to expose the surface of the electrostatic latent image bearer charged to form an electrostatic latent image;
a developing unit including the developing device according to <7> and configured to develop the electrostatic latent image using the developer to form a visible image;
a transfer unit configured to transfer the visible image to a recording medium; and
a fixing unit configured to fix an image transferred on the recording medium.
<10> A method for forming an image, the method including:
charging a surface of an electrostatic latent image bearer;
exposing the surface of the electrostatic latent image charged to form an electrostatic latent image;
developing the electrostatic latent image using the developing device according to <7> and the developer to form a visible image;
transferring the visible image to a recording medium; and
fixing an image transferred on the recording medium.

The toner according to any one of <1> to <4>, the toner stored container according to <5>, the developer according to <6>, the developing device according to <7>, the process cartridge according to <8>, the image forming apparatus according to <9>, and the method for forming an image according to <10> can solve the existing problems in the art and can achieve the object of the present disclosure.

### REFERENCE SIGNS LIST

1 process cartridge
2 photoconductor
3 charging unit
4 developing unit
5 cleaning unit

1: A toner comprising
inorganic particles,
wherein the inorganic particles include a fluorine-containing alumina, and
the toner satisfies both Formula (1) below and Formula (2) below:
2.75≤X1/X2≤5.5 Formula (1); and
2.1≤X1≤3.0 Formula (2)
where X1 denotes a concentration of aluminum in the toner and X2 denotes a concentration of fluorine in the toner, and the concentration of aluminum and the concentration of fluorine are determined through an X-ray photoelectron spectroscopic analysis method.

2: The toner according to claim 1,
wherein the toner satisfies both Formula (3) below and Formula (4) below:
2.8≤X1/X2≤5.2 Formula (3); and
2.1≤X1≤2.9 Formula (4)
where X1 denotes the concentration of aluminum in the toner and X2 denotes the concentration of fluorine in the toner, and the concentration of aluminum and the concentration of fluorine are determined through the X-ray photoelectron spectroscopic analysis method.

3: The toner according to claim 1, further comprising:
a release agent; and
a resin,
wherein the toner satisfies a ratio (W/R) of 0.05 or more but 0.14 or less where W denotes a peak height of a characteristic spectrum of the release agent and R denotes a peak height of a characteristic spectrum of the resin, and the peak height of the characteristic spectrum of the release agent and the peak height of the characteristic spectrum of the resin are measured through an attenuated total reflection method using Fourier transform infrared spectroscopy analysis measurement device.

4: The toner according to claim 1,
wherein the inorganic particles further include inorganic particles other than the fluorine-containing alumina, and
a median diameter of the inorganic particles other than the fluorine-containing alumina is 60 nm or more but 300 nm or less.

5: A toner stored container comprising:
the toner according to claim 1; and
a container,
the toner being stored in the container.

6: A developer comprising:
the toner according to claim 1; and
a carrier.

7: A developing device comprising:
the developer according to claim 6; and
a developer bearer configured to convey the developer while the developer bearer bears the developer,
wherein the developing device is configured to form an electric field in a position facing an electrostatic latent image bearer, and develop, using the developer, an electrostatic latent image formed on the electrostatic latent image bearer to form a visible image.

8: A process cartridge comprising:
an electrostatic latent image bearer; and
a developing unit including the developing device according to claim 7 and configured to develop, using the developer, an electrostatic latent image formed on the electrostatic latent image bearer to form a visible image, the process cartridge being detachably mounted in a body of an image forming apparatus.

9: An image forming apparatus comprising:
an electrostatic latent image bearer;
a charging unit configured to charge a surface of the electrostatic latent image bearer;
an exposing unit configured to expose the surface of the electrostatic latent image bearer charged to form an electrostatic latent image;
a developing unit including the developing device according to claim 7 and configured to develop the electrostatic latent image using the developer to form a visible image;
a transfer unit configured to transfer the visible image to a recording medium; and
a fixing unit configured to fix an image transferred on the recording medium.
